(19) United States
(12) Patent Application Publication
(10) Pub. No.: US 2019/0164386 A1
(43) Pub. Date: May 30, 2019

(54) WAGERING GAME WITH MULTIPLE POSITION BETTING

(71) Applicant: NORMAN M. MENDELSON, LYNNBROOK, NY (US)

(72) Inventor: NORMAN M. MENDELSON, LYNNBROOK, NY (US)

(21) Appl. No.: 16/044,022

(22) Filed: Jul. 24, 2018

Related U.S. Application Data
(60) Provisional application No. 62/592,184, filed on Nov. 29, 2017.

(51) Int. Cl. G07F 17/32; A63F 5/04; G07C 15/00; A63F 9/04

(52) U.S. Cl. CPC G07F 17/3269; G07F 17/3213; A63F 2009/0437; G07C 15/006; A63F 9/0415; A63F 5/04

(57) ABSTRACT

The wagering game with multiple position betting is a wagering game played using four separate clock faces, all bearing the same repeating sequential series of indicia, allowing for bets to be placed upon the outcome of up to four randomly determined outcomes in a single wager. Each clock face has a single hand selectively rotated to stop at a random position. The clock faces may be separately identified by indicia, such as size and color designations. The three additional clock faces are disposed within the main clock face. When the start button is pressed, the hands of each face spin for randomly determined periods, resulting in four unique wagering positions being identified per wager. In an alternative embodiment, the wagering game may include at least three colored wheels and at least three random number generators.

### CROSS REFERENCE TO RELATED APPLICATIONS

This application is the nonprovisional application of provisional application 62/592,184, filed Nov. 29, 2017, entitled Wagering Game With Multiple Position Betting, the priority of which is claimed.

### BACKGROUND

### 1. Field

The disclosure of the present patent application relates to gaming, and particularly to a wagering game with multiple position betting.

### 2. Description of the Related Art

Wagering games based upon varying odds have been known for a long time. Traditional wagering games, such as roulette or craps, generally permit players to wager on one or more possible outcomes, based upon the final position of a ball on the roulette wheel or the result of the roll of a pair of dice. These traditional wagering games tend to proceed slowly when compared to modern alternative entertainments and require the players to learn a complicated betting system.

Recent trends in the gaming industry have focused on faster paced, more immediately rewarding games, such as slot machines and video poker. These devices reward players based upon a preset result formula (slot machines) or a player-selected bet (video poker).

Thus, a wagering game with multiple position betting solving the aforementioned problems is desired.

### SUMMARY

The wagering game with multiple position betting may be designed as a table game with a physical clock face, as a fully electronic game displayed on a screen, as part of an application optimized for use on a mobile device, or using any alternative technological embodiment capable of performing the wagering game with multiple position betting as otherwise described herein.

In a first embodiment, the wagering game with multiple position betting has a main clock face and a plurality of smaller clock faces set into the main clock face. The clock faces incorporate multiple sequentially repeating number series. The smaller clock faces are individually identified by distinguishing indicia, such as distinct colors for each smaller clock face. This combination of features allows for repeating results for a single clock face, but distinct results for each clock face.

In an alternative embodiment, the wagering game with multiple position betting may be played with at least three random number generators, all bearing a sequential series of indicia and separate unique identifiers. The random number generators may be in the form of dice, wheels on a slot machine, or any other appropriate form known in the art. Using the dice as an exemplary random number generator, the separate identifiers may be that the dice are different colors, such as red, white, and blue. The game may be played with dice having any number of sides greater than 6. For example, the game may be played with 10-sided or 12-sided dice. The dice may have a single sequential series of indicia on each face, or they may have multiple sequentially repeating series of indicia on their faces.

These and other features of the present disclosure will become readily apparent upon further review of the following specification and drawings.

### BRIEF DESCRIPTION OF THE DRAWINGS

FIG. 1 is a top plan view of an exemplary apparatus for playing a first embodiment of a wagering game with multiple position betting, the apparatus having a horizontally oriented clock face.

FIG. 2 is a flowchart illustrating the basic steps in the method of play of a wagering game with multiple position betting using the apparatus of FIG. 1.

FIG. 3 is a flowchart illustrating the basic steps in the method of play of a second embodiment of a wagering game with multiple position betting, the second embodiment using dice.

FIG. 4A is a block diagram illustrating the basic components of a local system for playing an electronic version of a wagering game with multiple position betting.

FIG. 4B is a block diagram illustrating the basic components of a networked system for playing an electronic version of a wagering game with multiple position betting.

FIG. 5 is a perspective view of a gaming device for playing a wagering game with multiple position betting.

FIG. 6 is a top plan view of an exemplary apparatus for playing an alternative embodiment of a wagering game with multiple position betting, the apparatus having at least three colored wheels.

FIG. 7 is a top plan view of an exemplary wheel for playing the alternative embodiment of a wagering game with multiple position betting of FIG. 6, the wheel being a colored wheel with a particular array of wagering positions.

FIG. 8A is a perspective view of exemplary twelve-sided die for use in the gaming apparatus of FIG. 6.

FIG. 8B is a perspective view of the face pattern for the twelve-sided die of FIG. 8A.

FIG. 9 is a top plan view of an exemplary lottery ticket for playing the wagering game with multiple position betting.

Similar reference characters denote corresponding features consistently throughout the attached drawings.

### DETAILED DESCRIPTION OF THE PREFERRED EMBODIMENTS

The wagering game with multiple position betting is a wagering game involving wagering on the outcome of at least one of at least three independent variables with a single bet. These variables may involve the selection of one of a sequential series of numbers using a random number generator. The random number generator may be implemented by spinning a clock hand, by a throw of dice, by rotation of slot machine wheels, by a computerized mathematical random number generator function, or by any other appropriate form known in the art.

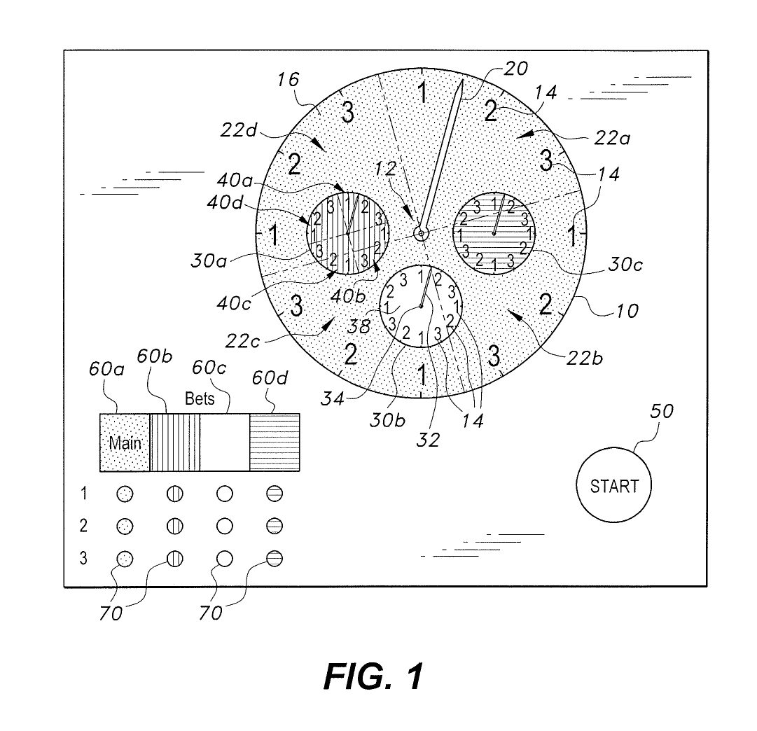

FIG. 1 of the drawings shows a clock face 10 according to the wagering game with multiple position betting. The clock hand 20 rotates around an axle 12 (or the clock hand is fixed to the axle 12, which rotates) oriented at an approximately 90° angle to the clock face 10. The rotation of the single clock hand 20, or the axle 12 when the clock hand 20 is fixed to the axle 12, is not continuous, but occurs only when triggered, and then at a random angle so that the hand 20 points to a random number on the clock face 10 when rotation stops. This may be done manually (e.g., by spinning the hand), or electronically (e.g., by servo motors connected to a controller activated by a random number generator). The evenly distributed wagering positions 14 disposed about the clock face periphery 16 are divided into zones or quadrants 22a-22d. Each zone or quadrant 22a-22d includes an entire sequential series of specific wagering positions 14.

Specific wagering positions 14 are described in accordance with the unique number provided for each position, e.g., in the exemplary clock face 10, the first quadrant 22a includes individual specific wagering positions labelled “1’, “2”, and “3’, and the second quadrant 22b includes individual specific wagering positions labelled “1”, “2”, “3”, etc. The wagering positions 14 of the exemplary clock face 10 of FIG. 1 comprise four quadrants 22a-22d, each with three sequentially labelled wagering positions, labelled “1”, “2”, and “3”.

The exemplary clock face 10 further includes additional clock faces 30a-30c disposed on the clock face 10. Each of these additional clock faces includes a clock hand 32, which rotates around an axle 34 oriented at an approximately 90° angle to the additional clock face 30, so that each clock hand 32 points to a random number on the clock face 30a-30c, as described above for the clock face 10. The evenly distributed wagering positions disposed about the additional clock face peripheries 38 are divided into zones or quadrants 40a-40d. Each zone or quadrant 40a-40d includes an entire sequential series of specific wagering positions 14.

Specific wagering positions are described in accordance with the unique number provided for each position, e.g., in the exemplary additional clock face 30a. The first quadrant 40a includes individual specific wagering positions 14 labelled by the indicia “1”, “2”, and “3”, and the second quadrant 40b includes individual specific wagering positions 14 also labelled by indicia “1”, “2”, and “3”, etc. The wagering positions of the exemplary additional clock faces 30a, 30b, and 30c of FIG. 1 comprise four quadrants 40a-40d, each with three sequentially labelled wagering positions, labelled “1”, “2”, and “3”.

The additional clock faces 30a-30c are distinguished by separate indicia labelling each unique additional clock face 30a-30c to allow their resulting values to be distinguished and wagered upon. In the exemplary clock face 10, the additional clock faces 30a-30c are individually distinguished by colors, such that the additional clock face 30a is red, the additional clock face 30b is blue, and the additional clock face 30c is white.

The clock face 10 includes a Start button 50, betting displays 60a-60d to display the wagering position 14 selected for the main clock face 10 and the additional clock faces 30a-30c, and buttons 70 to place bets, with each button assigned to a specific number and clock face color combination.

The wagering positions 14 allow players to place bets upon unique number and clock face combinations. Players may choose to bet on one or more clock face and number combinations. The repetition of each specific number in the different quadrants of a clock face increases the player's excitement during the game, by providing multiple potential winning results for any given bet.

In a further embodiment, at least one of the quadrants 22a-22d and the quadrants 40a-40d could be labelled with further unique indicia, such as colors. In this embodiment, each bet would include a specific clock face, quadrant, and number combination.

In a separate, further embodiment, the wagering positions 14 could have any sequential sequence of numbers, so long as all the quadrants in the clock face 10 and additional clock faces 30a-30c have the same sequence of numbers. For example, each quadrant could be numbered 0-9.

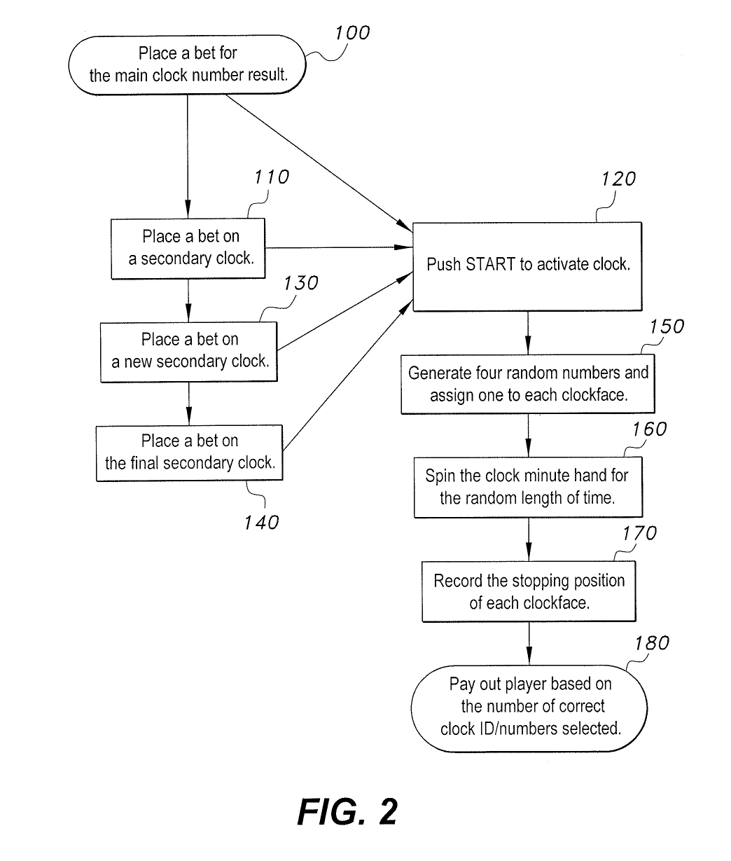

FIG. 2 provides a flowchart illustrating the basic steps in the method of playing the wagering game with multiple position betting using the apparatus of FIG. 1. These steps including placing a bet on the result of the main clock at step 100, and then selecting between an option of placing a further bet on an additional clock face at step 110 and activating the clock game by pressing the start button at step 120. If a further bet is placed, additional further bets may optionally be placed for each additional clock face at step 130, until a bet is entered for the final additional clock face at step 140. Each bet is recorded as a clock face and number combination in the betting displays 60a-d. After placing one or more bets, the user activates the clock game by pressing the start button at step 120. The game then generates random numbers and assigns a random number to each clock face at step 150. The clock faces then spin their hands for a length of time based upon the assigned random number at step 160. The stopping position and corresponding number is then recorded for each clock face at step 170, and wagers are paid based upon the number of clock face and number combinations recorded in the bet at step 180. The entire wager of a player placing a losing bet, defined as a bet not containing a single correct clock face and number combination, is collected by the house.

In an alternative embodiment, the wagering game with multiple position betting may be played using dice instead of clock faces. In this embodiment at least three dice are used, all bearing the same sequential series of indicia on each face, and separate unique identifiers for each die. The unique identifiers may be that the dice are different colors, such as red, white, and blue. The game may be played with dice having any number of sides greater than six. For example, the game may be played with 10-sided or 12-sided dice. The dice may have a single sequential series of numerical indicia, with a single number on each face, or they may have multiple sequentially repeating series of numerical indicia on their faces (e.g., nine faces, with the series 1-2-3 repeated three times, with a single number on each face). The game may be played by releasing the dice onto a surface from a player's hand. In the alternative, the game may be played by releasing the dice onto a surface from a physical container, including but not limited to a dice cup or a dice cage.

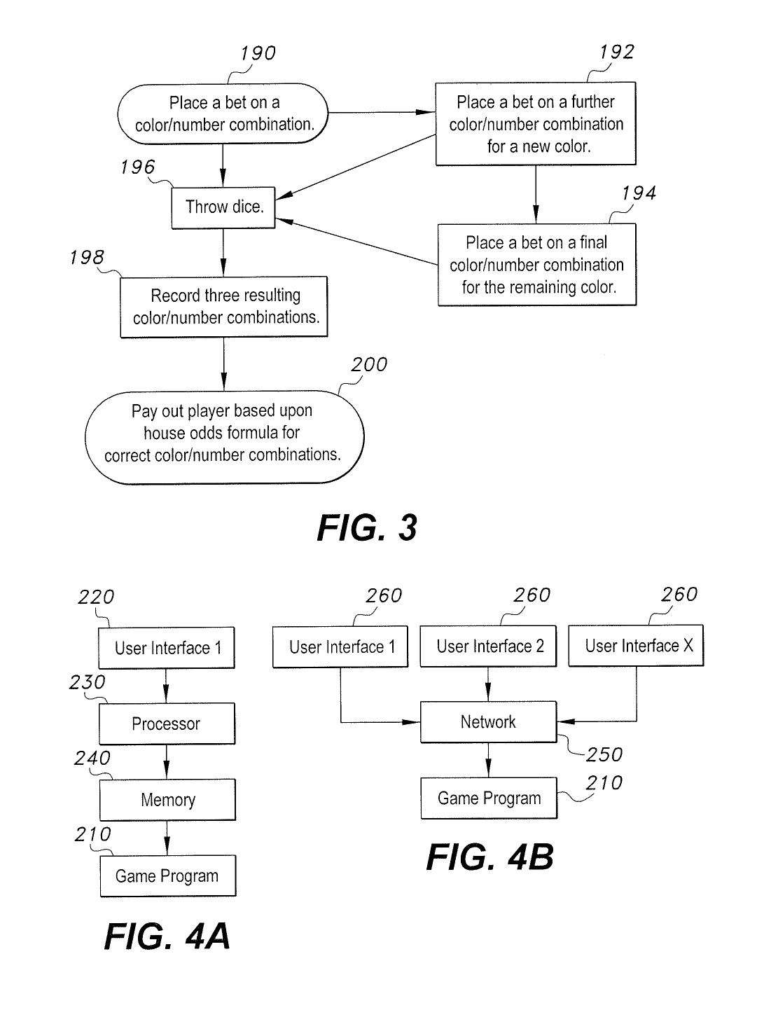

FIG. 3 provides a flowchart illustrating the basic steps in the method of playing the wagering game with multiple position betting using dice. In this embodiment, the game starts by recording a bet on at least one die color and number combination at step 190. After recording one or more bets, the player may choose between throwing the dice at step 196, or optionally placing further bets on new color and number combinations for a new color die at step 192, until the player places a bet upon a color and number combination for the final die color at step 194. When the dice are thrown at step 198, the resulting dice color and number combinations are recorded and wagers are paid based upon the number of correct color and number combinations included in the bet. The entire wager of a player placing a losing bet, defined as a bet not containing a single correct color and number combination, is collected by the house at step 200.

The wagering game with multiple position betting and methods of play have been described and illustrated as physical objects and actions. However, it is apparent that the wagering game with multiple position betting and its alternate embodiments may be adapted to computerized or electronic play.

FIG. 4A of the drawings provides a general example of such a standalone system for electronic play, comprising an electronic clock face game program 210 running on a computer, electronic game machine, electronic slot machine, or similar device having a user interface 220, processor 230, memory 240, and the game program 210 stored in the memory 240.

FIG. 4B of the drawings provides a general example of a network system for electronic play, comprising an electronic wagering game with multiple position betting program 210 running on a computer, electronic game machine, electronic slot machine, or similar device through a computer network 250. A series of individual user interfaces 260 may be used by players during simultaneous or sequential play, as desired. Such a system may be controlled locally or through any type of distributed network system (such as the Internet, an intranet, or a series of casino gaming stations controlled by a single, centralized computer system).

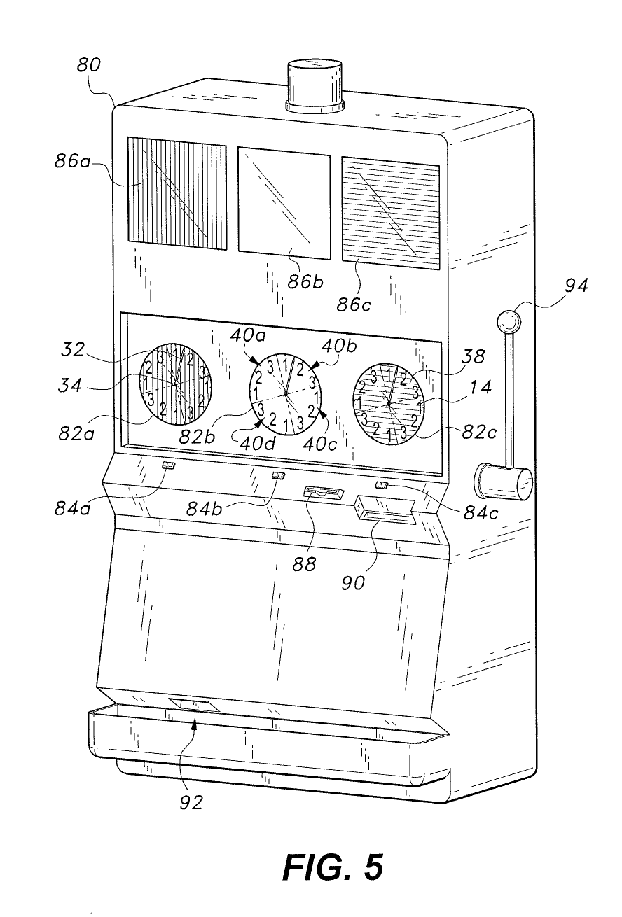

FIG. 5 illustrates a gaming device of the wagering game with multiple position betting. The gaming device 80 includes at least three random number generators, which may be clock faces 82a-c bearing indicia (such as distinct colors) to differentiate the clock faces 82a, 82b, 82c. The evenly distributed wagering positions disposed about the peripheries 38 of the clock faces 82a-c are divided into zones or quadrants 40a-40d. Each zone or quadrant 40a-40d includes an entire sequential series of specific wagering positions 14. Each of these clock faces 82a-c includes a clock hand 32, which rotates around an axle 34 (or the clock hand is fixed to the axle 34, which rotates) oriented at an approximately 90° angle to the clock face 82a-c. The rotation of the single clock hand 32, or the axle 34 when the clock hand 32 is fixed to the axle 34, is not continuous, but occurs only when triggered, and then at a random angle so that the hand 32 points to a random number on the clock face 82a-c when rotation stops.

The gaming device 80 includes a plurality of wagering buttons 84a-c and a plurality of wagering displays 86a-c. The individual wagering displays 86a-c and wagering buttons 84a-c correspond to the individual clock faces 82a-c. This may be indicated by positioning in relation to the clock faces 82a-c, by labelling with indicia corresponding to the indicia found upon the clock faces 82a-c, or by a combination of position and labelling. The game is played by depositing at least one bet in the coin slot 88 or the bill acceptor 90, placing at least one wager by pressing at least one wagering button 84a-c, and pulling the lever 94. With each press of a wagering button 84a-c, a corresponding wager is displayed in the corresponding wagering display 86a-c. After the lever 94 is pulled, the gaming device generates a random number for each individual clock face 82a-c and the clock hands 32 rotate to around the clock face, arriving at a randomly determined wagering position 14. Winning wagers are determined by comparing the number at the randomly determined wagering positions 14 with the number recorded on the corresponding wagering display 86a-c. The payout to the player may be increased based upon the number of winning wagers recorded in a single game. Winning wagers are paid through the payment slot 92.

In an alternative embodiment, the random number generators of the gaming device 80 may be colored wheels, each bearing a sequential series of specific wagering positions. These positions may be labelled with a sequential series of numbers, or with a repeating sequential series of numbers. For example, on a wheel with twelve wagering positions the positions may be labelled “1”, “2”, “3”, “4”, “5”, “6”, “7”, “8”, ‘9”, “10”, “11”, and “12”; or the wagering positions may be labelled “1”, “2”, “3”, “1”, “2”, “3”, “1”, “2”, “3”, “1”, “2”, “3”. The gaming device may have three or more colored wheels, each with three or more wagering positions. The repeating series of numbers may be any series of two or more numbers.

Further embodiments of the wagering game with multiple position betting may distinguish the additional clock faces with different indicia, such as unique numbers, images, or other labels.

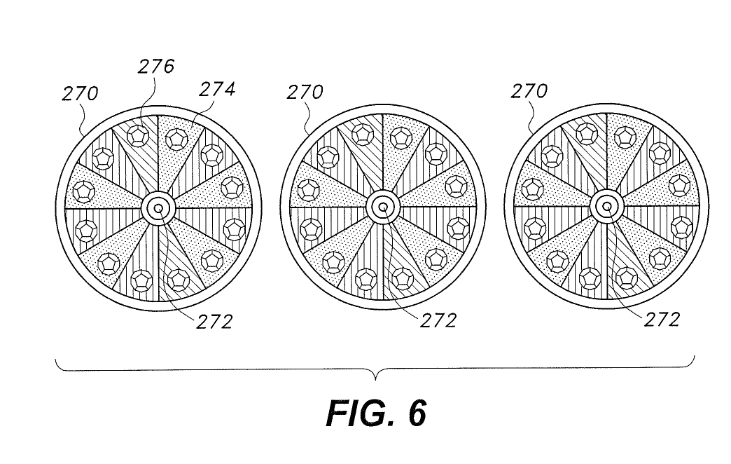

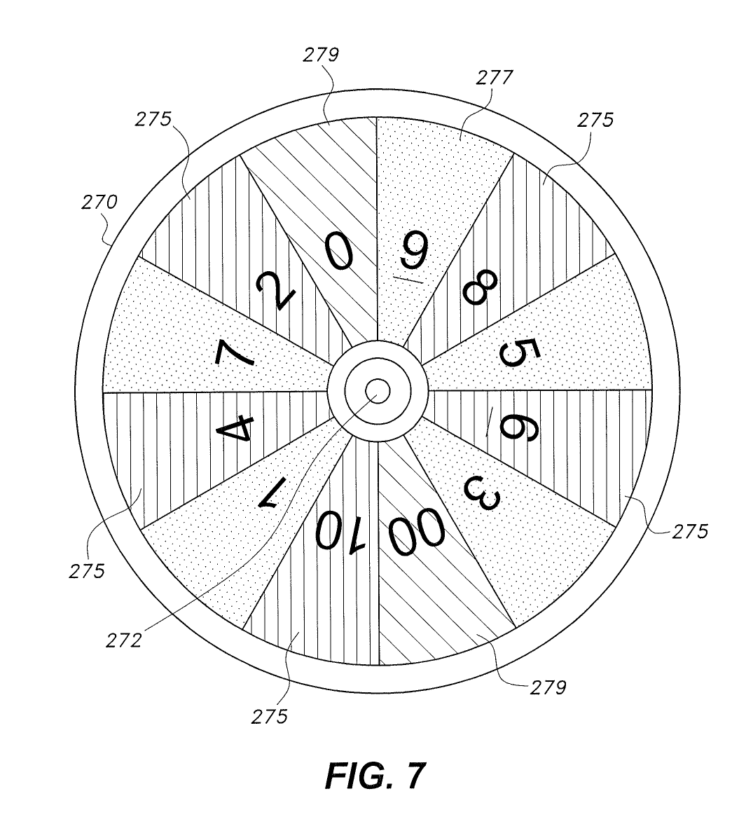

FIG. 6 illustrates another alternative gaming device of the wagering game with multiple position betting. The alternative gaming device of FIG. 6 includes at least one colored wheel 270, but preferably three colored wheels 270 are used, each bearing a sequential series of specific wagering positions 274. These positions may be labelled with a sequential series of numbers or colors, or with a repeating sequential series of numbers or colors. For example, as shown in FIG. 7, on a wheel with twelve wagering positions, the top position may be green 279, proceeding clockwise with alternating red 277 and black 275 positions until the bottom most position, which may also be green 279, and then the positions may alternate red 277 and black 275 back to the top position. In a further example, the wagering positions 274 may be labelled in repeating sequential series of black and red with no green spaces. In a further example, the wagering positions 274 may be labelled in repeating sequential series of black and red with a single green space.

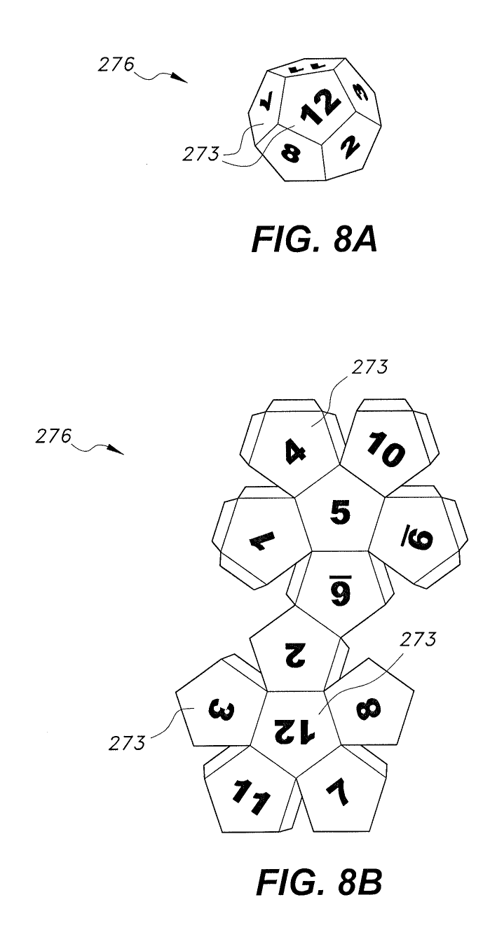

The alternative gaming device also includes at least one but preferably three random number generators 276, which may be dice, and in a preferred embodiment may be twelve-sided dice. Each random number generator 276 is assigned to an individual colored wheel 270. As shown in FIGS. 8A-8B, the dice 276 may have a single sequential series of numerical indicia, with a single number on each face 273, or they may have multiple sequentially repeating series of numerical indicia on their faces (e.g., twelve faces, with the series 1-2-3 repeated three times, with a single number on each face). The sequential series may run 0-11, 1-12, or any other sequential series of numbers.

In an embodiment when the game is activated, the colored wheels 270 may rotate around a central axis 272, causing the dice 276 to roll to a randomly selected wagering position 274 and display a randomly selected die face. Alternatively, or in combination with the former, the random generator may also change the colors of the positions. Therefore, instead of having “fixed” color and correspondingly “fixed” number thereon, either or both can be subjected to random generation thereby providing for a totally random and exciting experience.

In an alternative embodiment, the alternative gaming device of FIG. 6 may be partially or wholly adapted to computerized or electronic play. The electronic play may be implemented on any electronic device, such as a tablet, a cellular phone, or a slot machine.

When playing the game using the alternative gaming device of FIG. 6, the colored wheels 270 are spun as the random number generator is activated, whether by releasing a die 276 onto each spinning colored wheel 270 or by electronically rolling a die 276 and producing a randomly determined number and wagering position 274 for each die.

When playing the game using the alternative gaming device, a bet is placed for each colored wheel, with each bet representing a color and number combination. A winning wager may include a correct number and colored wheel, a correct color and colored wheel, a correct color, number, and colored wheel, or multiple correct colors, numbers, and colored wheels. Payouts may be determined based upon the odds of a particular successful wager occurring.

In a further embodiment, the wagering game with multiple betting positions may include a modified pinball-style machine. In this embodiment, at least one ball, but preferably three steel balls are propelled by the user in a traditional pinball-spring-lever style, travel over, around, over and through obstacles, play music, and are, to a visible extent, controlled by the player through the use of pinball flippers, as the ball travels around the machine, seeking to reach the independent 5 red, 5 black, and 2 green wagering positions of three spinning wheels according to FIG. 6. Three different spinning wheels turn, and through random generation, the landing place is established, one wheel at a time. The interaction may be fun as it provides the player a perceived sense of control over the outcome.

In an alternative embodiment, the first of the three balls may be hyper-linked to the second, which will be propelled after the first lands, and the second may propel the third. A record of the hits, or results, may be displayed on the backboard of the pinball-style machine.

In a further embodiment, an electronic die may be used and the selected color, number, odd, even, or other result may be displayed in lights on the backboard of the pinball-style machine. The second ball may be propelled, either by the user shooting another ball electronically or via hyperlink. Unlike the traditional pinball game, the ball will not be able to fall through a hole and be lost. Since it has a bet upon it, the bottom hole will be physically blocked and flippers, bumpers, or some other means placed in its stead to continue the ball until it lands in a wheel.

In a further embodiment, for the sake of economy a single wheel could be used three times with the score (Red, Black, Numbers, Odd, Even) kept on a scoreboard on the backboard of the pinball-style machine.

In an alternative version of the above pinball-style machines, a player can use the pinball format to generate their own number, color or combination and then record the results as a bet and generate a ticket with the bet or electronically record the bet in an electronic account. Conventionally, the account can be a pre-established account for the player or an account established at the time of play. Alternatively, the players can preselect their wager (color, number, or combination of the two), dispense a ball as in pinball, and then affect the final location of the ball by use the bumpers and flippers of the pinball machine. This “interactive” feature of the wager and ultimate location of the ball is a significant difference over fixed outcome-type wagering, wherein once the bet is placed it cannot be changed. In an alternative embodiment, the landing zones for the dispensed ball can be made to continually change in color or number or even their location on the playing surface of the machine (for example, every 15-30 seconds) as further enhancement of the excitement of “interactive” wagering.

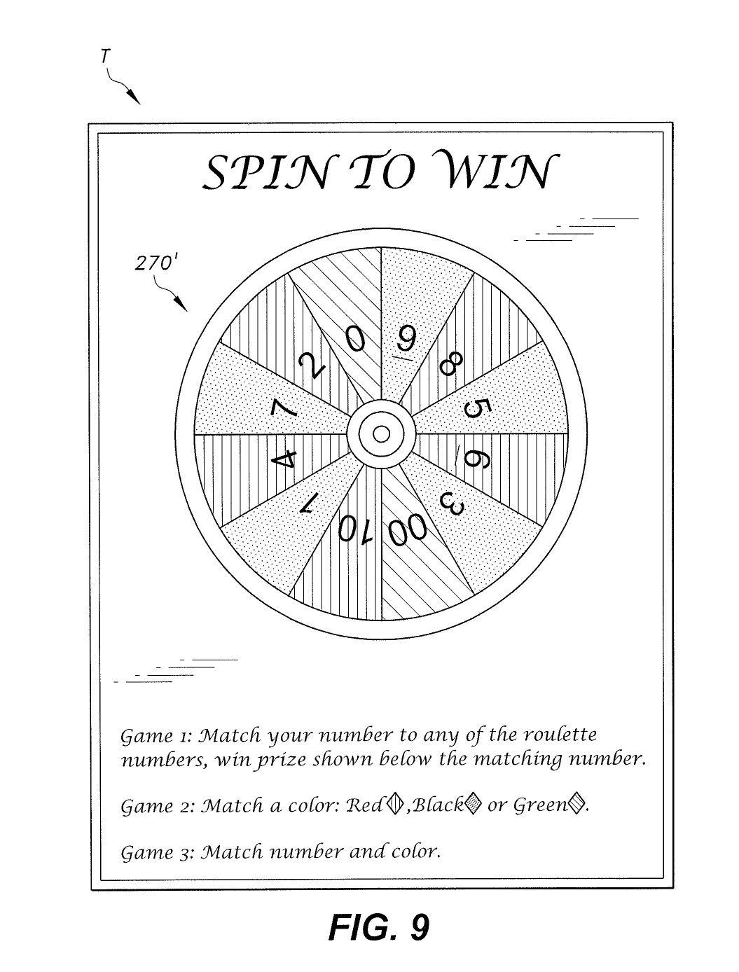

FIG. 9 illustrates another alternative gaming “device” of the wagering game with multiple position betting. The alternative gaming “device” of FIG. 9 includes at least one colored wheel 270′ designed as seen in FIG. 7 but as part of a lottery ticket or “scratch-off” type ticket T. In this exemplary illustration, an “instant winner-type” scratch off version is depicted. For example, the player can select a number and scratch off the roulette number to see if it's a match and win the prize shown below the matching number. The player can do the same for color alone and combinations of number and color and match the results and prizes, if any. In any version, the player can purchase a number or color or combination and await a daily “drawing” of the results to see if it's a winning bet. An alternative version of the lottery game is a hybrid version of lottery ticket-pinball game merger. The player would place their bet, play the pinball game and have the results printed out as proof of the wager, the outcome of the game, and the amount won, if any.

It is to be understood that the wagering game with multiple position betting is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A method of playing a wagering game with multiple position betting, comprising the steps of:
providing at least one wheel, the at least one wheel including:
a plurality of evenly distributed wagering positions disposed peripherally about the wheel face;
indicia defining a plurality of sequentially repeating number sequences disposed upon the wagering positions of the wheel face, the wheel face being divided into quadrants, each of the quadrants containing an entire one of the sequentially repeating number sequences;
placing at least one wager upon at least one of the wagering positions of the wheel face, the wager being recorded in a betting display;
pressing the start button, thereby randomly selecting a winning wagering position on the at least one wheel face;
paying out players based upon the number of correct wagering positions in a single wager; and
collecting the entire wager of a player placing a losing bet.

2. A method of playing a wagering game with multiple position betting, comprising the steps of:
providing at least three random number generators, each of the random number generators including a unique identifier and at least one sequential series of numbers disposed on separate faces of the random number generator;
recording at least one wager upon at least one random number generator and number combination;
generating a random number using the random number generator;
paying winning wagers based upon the number of random number generator and number combinations correctly predicted; and
collecting the entire wager of a player placing a losing bet.

3. A wagering game system with multiple position betting devices, comprising:
at least three colored wheels, each of the colored wheels bearing a sequential series of wagering positions;
at least three central axes, the at least three colored wheels being adapted to rotate around a corresponding one of the at least three central axes, respectively; and
at least three random number generators, the at least three random number generators being adapted to generate a single random number for each of the at least three colored wheels;
wherein activation of the wagering game results in generation of at least three random number generator results paired with at least three wagering positions results displayed individually on the at least three colored wheels.
